(19) United States
(12) Patent Application Publication
(10) Pub. No.: US 2005/0226205 A1
(43) Pub. Date: Oct. 13, 2005

(54) Network resource-controlled service provision

(75) Inventors: Albert Kain, Wien (AT); Sumio Miyagawa, Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/091,339

(22) Filed: Mar. 29, 2005

(30) Foreign Application Priority Data
Mar. 29, 2004 (DE) 10 2004 015 267.5

(51) Int. Cl. H04L 12/66; H04J 3/14

(52) U.S. Cl. 370/349; 370/352

(57) ABSTRACT

The invention describes a method and device for providing network resources for the transmission of data of at least one service from an application server to a communication terminal via a communication network. According to the invention, a decision is made by a Policy Decision Function concerning the provision of network resources in at least one network element, for the transmission of data of at least one service from the application server to the communication terminal. The decision that is made is then transmitted, as a message, to a first network unit and to an additional network unit. If the decision is positive, the first network unit thereupon provides network resources for the transmission of data of at least one service to the communication terminal.

### CLAIM FOR PRIORITY

This application claims the benefit of priority to German Application No. 10 2004 015 267.5 which was filed in the German language on Mar. 29, 2004, the contents of which are hereby incorporated by reference.

### TECHNICAL FIELD OF THE INVENTION

The invention relates to a method and device for providing network resources (QoS) for the transmission of data of at least one service from an application server (AS) to a communication terminal (MS) via a communication network.

### BACKGROUND OF THE INVENTION

In what is known as an intelligent network (IN or ISDN, Integrated Services Digital Network), supplementary services are offered to network subscribers in addition to the basic services provided by the telecommunication network, such as—for example—a number conversion service for setting up abbreviated numbers or a caller control service (control of user) whereby the subscriber can only be reached by selected callers. In a known method for implementing these services, a service control station is provided in the intelligent network, said service control station generally being separate from the switching equipment of the intelligent network.

In communication networks, particularly cellular mobile radio networks, base stations are connected to the switching equipment (MSC), the base stations being used for connecting communication terminals via a radio interface. These terminals enable a user of a mobile network to access the network. The switching equipment is additionally equipped for transfer to further networks, e.g. to a data transfer network or a fixed network. Various protocols are currently used for communication between the switching units, such as the INAP protocol (Intelligent Network Application Part) of the European Telecommunication Standards Institute (ETSI) or the MAP (Mobile Application Part) protocol of the GSM standard. These protocols are normally used within the network. Furthermore, a so-called CAMEL (Customized Application for Mobile Network Enhanced Logic) platform is known from the ETSI specifications GSM 03.78 and GSM 09.02, which is used for supporting additional, supplier-specific services for subscribers. The CAMEL standard defines a CAP (CAMEL Application Part) protocol for this purpose, within which signaling messages are interchangeable between the Home Location Register (HLR) and a service control station (application server or application function). CAMEL and the transmission of data of a service by means of GPRS (General Packet Radio Service), is considered in greater detail in Standard 3GPP TS 23.078.

The expansion of a cellular mobile radio network with the Policy Decision Function (PDF) and its functions is presented in 3GPP TR 23.917. The Policy Decision Function is a network unit of an IP multimedia subsystem (IMS), which permits or refuses the provision of network resources if these are requested by an application server (application function) that offers a service for a user of a communication terminal. The Policy Decision Function (PDF) therefore serves to adjust the quality of service (QoS) and is connected to the core network via the Gq interface. On the basis of the decision by the Policy Decision Function, the access network of the communication network, in GPRS (General Packet Radio Service) generally the SGSN (Serving GPRS Support Node) and the GGSN (Gateway GPRS Support Node), provides the network resources.

The use of GPRS (General Packet Radio Service) is specified in the 3GPP standard 3GPP TS 23.060. The packet domain uses packet mode techniques to transfer data and signals efficiently. The packet domain optimizes the use of network and radio resources and is used by second-generation radio access networks (RANs) as well as by third-generation radio access networks, the GERAN (GSM EDGE Radio Access Network) and the UTRAN (UMTS Terrestrial Radio Access Network). The core network of a communication network supports GPRS services together with the radio access networks and is designed to support various quality of service levels. This facilitates the efficient transmission of a service's realtime (voice, video, etc.) and non-real-time data. Applications that use standard data protocols and SMS are also supported, as is interoperation with an IP network. Services may be charged for on a flexible basis, with facilities for billing according to the quantity of transferred data, the quality of service supported (QoS), and the duration of the connection. The SGSN (Serving GPRS Support Node) monitors the location of a communication terminal and executes security functions and access controls. The SGSN is also connected to the GERAN base station system via the Gb or the Iu interface and/or in the UTRAN via the Iu interface. The SGSN is also connected, via a GPRS Service Switching Function (gprsSSF), to a GSM Service Control Function (gsmSCF) for optimum use of CAMEL and in order to support cost control services. The GGSN (Gateway GPRS Support Node) supports interoperation with a packet data network and is connected to the SGSN via a GTP (GPRS Tunneling Protocol) tunnel. The GGSN is connected to an IP-based packet network (IP-based packet domain PLMN (Public Land Mobile Network) backbone network).

### SUMMARY OF THE INVENTION

The invention discloses an efficient and cost-effective option for providing network resources for the transmission of data of a service.

One embodiment of the invention is that a decision made by a Policy Decision Function with regard to whether to permit or refuse the provision of network resources in at least one network element for the transmission of a service from an application server to a to a communication terminal, is transmitted both to a first network unit (GGSN), and to an additional network unit (gsmSCF). Said decision may be transmitted in a message to a first network unit (GGSN) and to an additional network unit (gsmSCF). It is possible for the decision to be transmitted to the additional network unit (gsmSCF=SCF) in a CAP initialization message (CAP Initial DP GPRS) via a Serving GPRS Support Node (SGSN), or for the decision to be forwarded directly from the first network unit (GGSN) to the additional network unit (service control function). A big advantage of this invention is that the functions of the Policy Decision Function may be used for services, in particular CAMEL services. This means that the distribution of network resources, for example the quality of service (QoS), the transmission bandwidth, etc. can be distributed more efficiently and more cost-effectively for the transmission of data of a service.

### BRIEF DESCRIPTION OF THE DRAWINGS

The invention will now be explained in greater detail on the basis of an exemplary embodiment illustrated by a diagram, in which

FIG. 1 shows a first option for the transmission of a decision to the Policy Decision Function.

FIG. 2 shows a second option for the transmission of a decision to the Policy Decision Function.

FIG. 3 shows a simplified view of a device according to the invention.

### DETAILED DESCRIPTION OF THE INVENTION

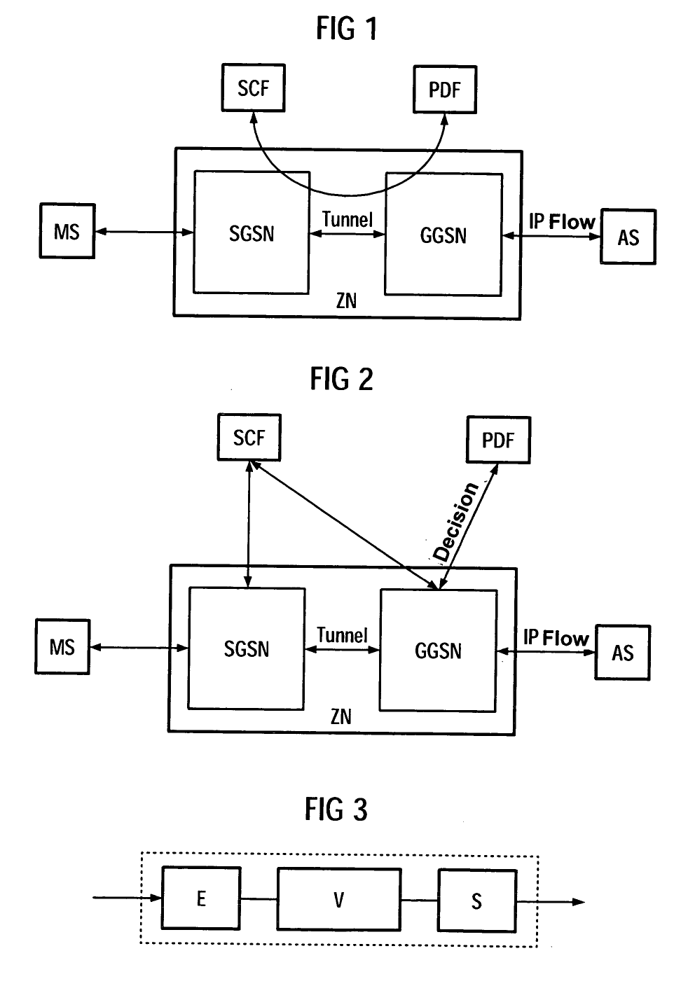

FIG. 1 shows a simplified view of a communication network, in particular a cellular mobile radio network, with a communication terminal MS that receives data of at least one service from an application server AS via an access network ZN. A communication terminal MS may be a mobile radio terminal, a portable computer, a computer, a portable organizer or similar. The access network ZN generally comprises, for example, a Serving GPRS Support Node SGSN, which is connected to a Gateway GPRS Support Node GGSN via a GPRS tunnel or GTP tunnel. The Serving GPRS Support Node SGSN is connected to a service control function SCF. Said service control function SCF is generally also called the CAMEL Service Environment (CSE). A Policy Decision Function PDF in an IP multimedia subsystem is connected to the Gateway GPRS Support Node GGSN in the access network ZN.

If a CAMEL service user creates a GPRS PDP context with his or her communication terminal MS on request, the information is transmitted to the service control function SCF. Said information contains a quality of service (QoS) parameter, which is used mainly for charging purposes. The quality of service parameter is only a generic parameter which is currently used for registering charges and network resources for users and their communication terminals MS.

According to the invention, a Policy Decision Function PDF decides whether network resources are to be permitted or refused for the transmission of data of at least one service from the application server AS to the user's communication terminal MS. The decision made by the Policy Decision Function PDF is transmitted as a message to a GGSN, which provides the network resources according to the decision. The decision relates to the network resources to be allocated for the transmission of data of at least one service, said network resources comprising—for example—transmission bandwidth, quality of service, etc. In addition, the decision is forwarded in a CAP initialization message (CAP Initial DP GPRS) or other message to the service control function (SCF) via the SGSN. It is sometimes possible, when a request is received from the application server AS that the Serving GPRS Support Node SGSN or the Gateway GPRS Support Node GGSN cannot be provided as many resources as were permitted by the Policy Decision Function PDF. If this happens, the user of the service will not be satisfied with the quality of service. A possible solution might be for the user to receive a price reduction for the transferred data of at least one service. Conversely, it is also possible for the Serving GPRS Support Node SGSN or the Gateway GPRS Support Node GGSN to provide more network resources than the Policy Decision Function PDF permits. The user might then be asked, for example, whether he or she would like to have a better quality level for the service. The charges registered could then also be adjusted.

FIG. 2 shows a simplified view of a communication network according to FIG. 1. According to the invention the decision made by the Policy Decision Function PDF to permit or refuse the provision of network resources in at least one network element SGSN/GGSN for the transmission of data of at least one service from the application server AS to the communication terminal MS is forwarded directly from the Gateway GPRS Support Node GGSN to the service control function SCF. This decision is forwarded in a message, in particular a CAP message, to the service control function SCF.

FIG. 3 shows a simplified device for executing the method according to the invention. The device has a transmitter unit S and a receiver unit E for mobile communication with a communication network, in particular a cellular mobile radio network. A processing unit V is used to make a decision concerning the provision of network resources and/or of quality of service in at least one network element (SGSN/GGSN) of the communication network. The decision made by the processing unit V is transmitted in a message from the transmitter unit S to a first network unit GGSN and to an additional network unit SCF. The first network unit GGSN, which receives the decision by the device, in particular by the Policy Decision Function PDF, provides the permitted network resources in at least one network element (SGSN/GGSN) for the transmission of data of at least one service from an-application server AS to a communication terminal MS.

1. A method for providing network resources for the transmission of data of at least one service from an application server to a communication terminal via a communication network, comprising:
providing a decision made by a Policy Decision Function concerning provision of network resources in at least one network element, for the transmission of data of at least one service from the application server to the communication terminal;
transmitting the decision that has been made, as a message, to a first network unit, and to an additional network unit; and
in that, if the decision is positive, the first network unit provides network resources for the transmission of data of at least one service to the communication terminal.

2. The method according to claim 1, wherein the Policy Decision Function is a unit of the IP multimedia subsystem.

3. The method according to claim 1, wherein a service control function (SCF) is used as an additional network unit.

4. The method according to claim 1, wherein a Gateway GPRS Support Node is used as the first network unit.

5. The method according to claim 1, wherein the decision made by the Policy Decision Function is transmitted to the additional network unit, in a CAP initialization message, via a Serving GPRS Support Node.

6. The method according to claim 1, wherein the decision made by the Policy Decision Function is forwarded directly from the first network unit (GGSN) to the additional network unit.

7. The method according to claim 1, wherein a Policy Decision Function makes a decision on whether the provision of network resources is to be permitted or refused.

8. The method according to claim 1, wherein a decision to permit the provision of network resources is regarded as being a positive decision.

9. The method according to claim 1, wherein the decision contains a quality of service parameter in a message.

10. The method according to claim 1, wherein the quality of service parameter is used for charge registration of the data to be transmitted for at least one service.

11. The method according to claim 1, wherein the charges registered are dependent upon the network resources allocated for the transmission of data of at least one service.

12. The method according to claim 1, wherein the transmission bandwidth is deemed to be a network resource.

13. The method according to claim 1, wherein at least one service is a CAMEL service.

14. The method according to claim 1, wherein a cellular mobile radio network is used as the communication network.

15. A device for providing network resources for the transmission of data of at least one service from an application server to a communication terminal via a communication network, comprising:,
a transmitter unit and a receiver unit for the Policy Decision Function for mobile communication with a communication network;
a processing unit in the Policy Decision Function for making a decision concerning the provision of network resources in at least one network element, for the transmission of data of at least one service from the application server to the communication terminal;
a transmitter unit for transmitting, as a message, the decision that has been made to a first network unit and to an additional network unit; and
a first network unit for providing network resources if the decision is positive, in at least one network element for the transmission of data of at least one service to the telecommunication terminal.

16. The device according to claim 15, wherein a cellular mobile radio is provided as the communication network.

17. A device according to claim 15, wherein the Policy Decision Function is provided as a unit of the IP multimedia subsystem.

18. A device according to claim 15, wherein a Gateway GPRS Support Node is provided as the first network unit.

19. A device according to claim 15, wherein a service control function is provided as an additional network unit.

20. A device according to claim 15, wherein the Policy Decision Function is provided for transmission of the decision that has been made, the decision being transmitted to the additional network unit in a CAP initialization message via a Serving GPRS Support Node.

21. A device according to claim 15, wherein the first network unit is provided for transmitting, in a message, the decision made received from the Policy Decision Function to the additional network unit.
